(19) United States
(12) Patent Application Publication
(10) Pub. No.: US 2018/0179908 A1
(43) Pub. Date: Jun. 28, 2018

(54) SEALING SYSTEM FOR A ROTATING MACHINE

(71) Applicants: ANSALDO ENERGIA S.p.A., Genova (IT); ANSALDO ENERGIA SWITZERLAND AG, Baden (CH)

(72) Inventors: Alessio D'ALESSANDRO, Genova (IT); Cyrille BRICAUD, Rheinfelden (DE)

(73) Assignees: ANSALDO ENERGIA S.p.A., Genova (IT); ANSALDO ENERGIA SWITZERLAND AG, Baden (CH)

(21) Appl. No.: 15/852,772

(22) Filed: Dec. 22, 2017

(30) Foreign Application Priority Data
Dec. 22, 2016 (EP) 16425115.9

(51) Int. Cl. F01D 11/08; F01D 11/00; F04D 29/16; F04D 29/10

(52) U.S. Cl. CPC F01D 11/08; F01D 11/001; F04D 29/16; F05D 2260/30; F05D 2220/32; F05D 2240/55; F04D 29/10

(57) ABSTRACT

The sealing system for a rotating machine comprises a fixed part and a movable part. The fixed part is connectable to a stator of a rotating machine and the movable part is connected to and movable to and fro the fixed part. The movable part is mechanically disconnected from the fixed part. The sealing system comprises a retainer to prevent separation of the movable part from the fixed part.

This application claims priority from European Patent Application No. 16425115.9 filed on Dec. 22, 2016, the disclosure of which is incorporated by reference.

### TECHNICAL FIELD

The present invention relates to a sealing system for a rotating machine. The rotating machine can be in different examples a turbine, such as a turbine or a compressor part of a gas turbine engine or a steam turbine, a turbogenerator or a hydro generator; other rotating machines are anyhow possible.

### BACKGROUND

In the following reference to a turbine which is part of a gas turbine engine is made; it is anyhow clear that the sealing system can be applied also to different machines as exemplified above.

Gas turbine engines are known to comprise a compressor, one or more combustion chambers and one or more turbines. The turbines have a stator and a rotor, which is rotatable within the stator. Between the stator and the rotor a hot gas duct is defined, though which hot gas generated in the combustion chamber passes through. The stator carries vanes that project into the hot gas duct and the rotor carries blades also projecting into the hot gas duct.

During operation air is compressed in the compressor and directed into the combustion chamber where a fuel is injected; compressed air and fuel are combusted in the combustion chamber generating the hot gas that is directed into the turbine, in particular through the hot gas duct. While passing through the hot gas duct the hot gas expands and mechanical work is collected by the rotor through the blades.

In order to obtain high efficiency, the hot gas should not leak through a zone of the hot gas duct between the tip of the blades and the stator.

Nevertheless, during operation the different parts of the turbine can undergo thermal expansion or contraction; for this reason between the tip of the blades and the stator a relatively large gap must be provided, in order to prevent the blades from interfering with the stator. Such a situation would damage the gas turbine engine and has to be avoided.

In order to maintain the gap between the tip of the blades and the stator at a small size in different operating conditions sealing systems can be provided.

EP 2 971 586 A1, U.S. Pat. No. 8,932,001 B2, U.S. Pat. No. 9,255,642 B2, U.S. Pat. No. 9,359,908 B2 disclose sealing systems having a fixed part that is connected to the stator of the rotating machine and a movable part; the fixed part and the movable part are connected together by means of spring elements.

This sealing system is assembled with the fixed part connected to the stator in zones of the stator facing the tips of the blades and the movable part protruding towards the tip of the blades, without touching them.

During operation the size of the gap between the tip of the blades and the stator changes, e.g. because the rotating machine is colder at start up or because at low load it is colder than at full load. Those size changes are compensated by the movable part that radially moves under the pressure forces generated by the hot gas passing through the hot gas duct and lapping the movable part.

Nevertheless, the spring elements influence the movement of the movable part and thus affect the sealing effect, because the elastic features of the spring elements have stringent design constrains imposed by the geometric shape of the same spring elements.

In addition, often spring elements are complex to manufacture.

### SUMMARY

An aspect of the invention includes providing a sealing system for a rotating machine with good sealing capabilities, because the constraints of the elastic elements can be avoided or reduced.

Another aspect of the invention includes providing a sealing system with improved manufacturability.

These and further aspects are attained by providing a sealing system for a rotating machine in accordance with the accompanying claims.

### BRIEF DESCRIPTION OF THE DRAWINGS

Further characteristics and advantages will be more apparent from the description of a preferred but non-exclusive embodiment of the sealing system, illustrated by way of non-limiting example in the accompanying drawings, in which:

FIG. 1 shows a rotating machine such as a turbine with a sealing system in an embodiment of the invention;

FIGS. 2 and 3 show a sealing system in a first embodiment of the invention;

FIG. 4 shows a sealing system in a second embodiment of the invention;

FIG. 5 shows a front view of the sealing system of FIGS. 2 and 3.

### DETAILED DESCRIPTION OF EXEMPLARY EMBODIMENTS

With reference to the figures, these show a rotating machine 1 comprising a stator 2 and a rotor 3. The rotating machine can be a compressor, a turbine (e.g. a steam turbine or a turbine part of a gas turbine engine); the rotating machine can also be a turbogenerator or a hydro generator. In the following, an example in which the rotating machine is a turbine which is part of a gas turbine engine is made.

The stator 2 has vanes 5 and the rotor 3 has blades 6; the vanes 5 face the rotor 3 and the tips 8 of the blades 6 face the stator 2.

Between the stator 2 and the blade tips 8 sealing systems 10 are provided. The sealing systems 10 can be associated to each stage of the turbine, it is clear that the sealing system 10 can anyhow be provided only at one stage or also more than one stage but not all stages.

The sealing system 10 is connected to the stator 2 and protrudes in the hot gas duct 11 defined between the stator 2 and the rotor 3.

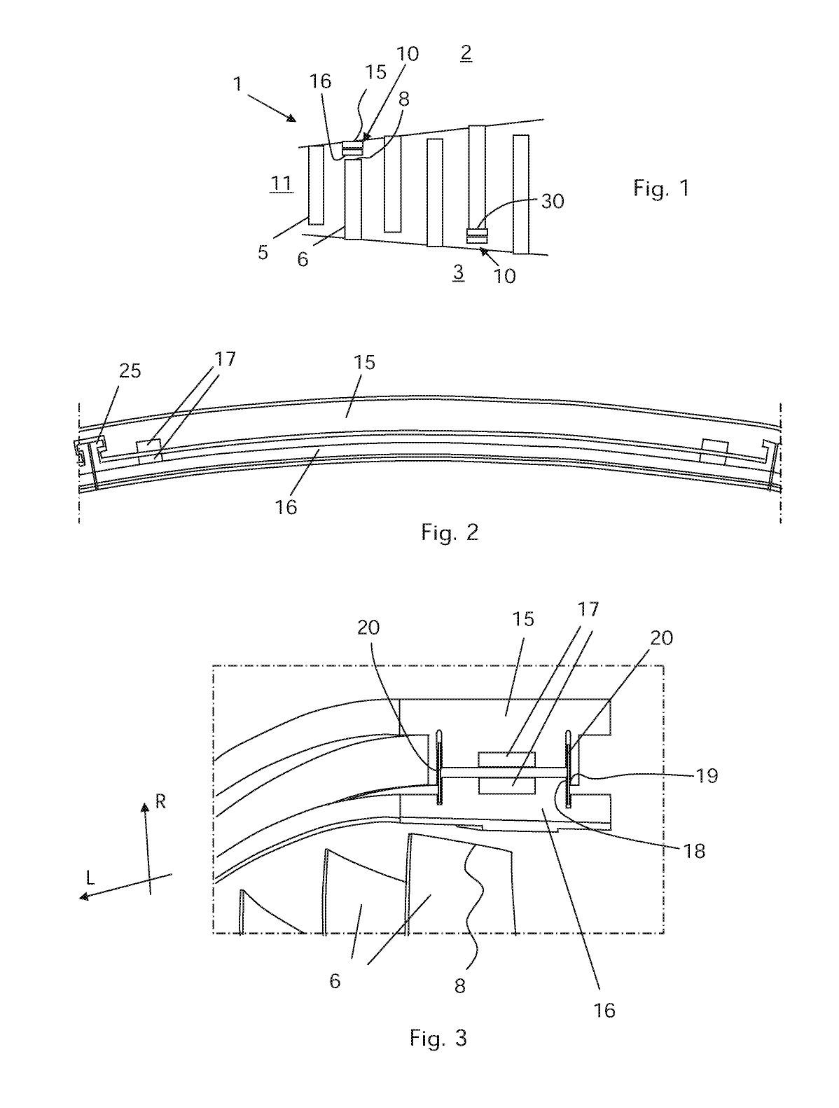

The sealing system 10 comprises a fixed part 15 and a movable part 16; the fixed part 15 is connectable to (and in FIG. 1 it is actually shown connected to) the stator 2 of the rotating machine 1.

The movable part 16 is coupled to and movable to and fro the fixed part 15. Coupled means that the fixed part 15 and movable part 16 define one unit or arrangement. In particular, the movable part 16 is movable in a radial direction R with respect to the turbine longitudinal axis L. Movement in the radial direction R allows adjustment of the distance of the movable part 16 with respect to the tip 8 of the blades 6.

The movable part 16 is mechanically disconnected from the fixed part 15.

Since no mechanical connection, such as elastic elements, is provided between the fixed part 15 and the movable part 16, the stringent constraints to the design and manufacture of the sealing system 10, imposed in the traditional sealing systems by the mechanical connection, can be overcome. Therefore the geometrical features of the sealing system 10 and the features for allowing the movement of the movable part 16 to and fro the fixed part 15 can be chosen and optimized in accordance with the flow features prevailing in the hot gas duct 11.

In addition, the sealing system 10 comprises a retainer to prevent separation of the movable part 16 from the fixed part 15, e.g. when the turbine is not in use (e.g. to prevent that the movable part falls on the rotor 3).

The retainer can comprise one or more magnets 17.

In one embodiment, the fixed part 15 or the movable part 16 can be provided with a magnet 17, in this case the magnet 17 cooperates with the ferromagnetic material or a ferromagnetic insert in the other element (i.e. in case the magnet 17 is on the fixed part 15, the ferromagnetic material or insert is in the movable part 16 and vice versa).

In another embodiment, both the fixed part 15 and the movable part 16 have a magnet 17, such that the magnets 17 cooperate together to guarantee that the movable part 16 is retained connected to the fixed part 15 when the turbine 1 is not in operation.

In further embodiments, the fixed part 15 and/or the movable part 16 can have one or more magnets 17, in order to precisely select the retaining magnetic force that pushes the movable part 16 towards the fixed part 15.

Advantageously the magnets can be precisely sized, in order to provide the required magnetic force pulling the movable part 16 against the fixed part 15. In contrast, when using elastic elements, typically it is difficult or it is not possible at all to provide the required elastic force, in view of the geometrical constraints the elastic elements have to meet.

Use of magnets thus allows to precisely select the magnetic force required to pull the movable part against the fixed part of the sealing system and/or to keep this force at a low intensity. Therefore, since the magnetic force can be precisely selected and calculated and/or is low (compared to the pressure force generated by the hot gas licking the movable part), its possible negative influence on the sealing effect can be counteracted.

In addition, the movable part 16 can also be movable parallel to the fixed part 15, i.e. the movable part 16 can move in a direction parallel to the longitudinal axis L of the turbine 1. In this case, advantageously, the movable part 16 has a surface 18 arranged to rest on a corresponding surface 19 of the fixed part 15 following a movement of the movable part 16 in a direction D parallel to the fixed part 15 (i.e. parallel to the longitudinal axis L).

The surface 18 of the movable part 16 extends towards the fixed part 15 and the stator 2; for example this surface 18 can extend in the radial direction R; other examples are anyhow possible and for example the surface 18 can be at an angle with the radial direction R.

In order to facilitate resting of the surface 18 of the movable part 16 onto the surface 19 of the fixed part 15, the surface 19 of the fixed part 15 is parallel to the surface 18 of the movable part 16. This advantageously counteracts hot gas leakage through the sealing system 10 and improves the sealing effect.

To further improve the sealing effect, one or more secondary seals 20 can be provided to prevent flow passage between the fixed part 15 and the movable part 16.

In this respect FIG. 3 shows secondary seals 20 between the surface 18 of the movable part 16 and the surface 19 of the fixed part 15.

A stop 25 can be further provided in addition to or as an alternative to the magnets 17 for preventing separation of the fixed part 15 from the movable part 16.

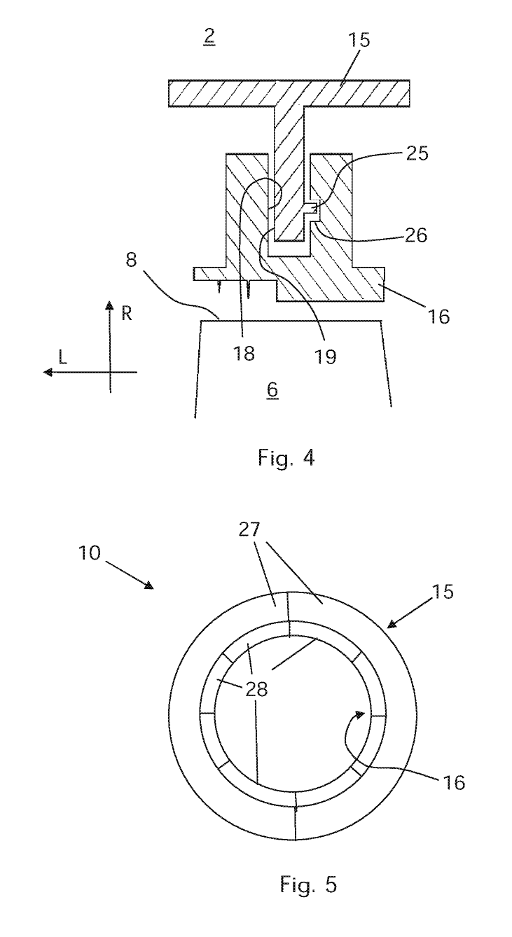

The stop 25 can be provided on the fixed part 15 and/or on the movable part 16 and is inserted into a recess 26 of the other element (i.e. if the stop 25 projects from the fixed part 15 like in FIG. 4 the recess 26 is on the movable part 16 and vice versa).

Between the stop 25 and recess 26 there is a clearance or play, to allow for adjustments of the movable part 16 and guarantee the sealing effect.

FIG. 2 shows an example in which the sealing system 10 has both the magnets 17 and the stop 25 as retainers. The stop 25 prevents separation and falling of the movable part 16 on the rotor 3. The magnets 17 maintain the sealing system 10 closed, i.e. when the turbine 1 is not in operation the magnets 17 maintain the movable part 16 connected (e.g. close) to the fixed part 15 by magnetic forces. In this case the stop 25 is thus redundant and is used to increase reliability.

FIG. 4 shows an example in which no magnets are provided; in this example the stop 25 prevents separation of the movable part 16 from the fixed part 15 (e.g. it prevents that the movable part 16 falls on the rotor 3 when the turbine 1 is not in operation).

Advantageously, the fixed part 15 has a circular shape and comprises at least two sections 27 (of same or different size) and the movable part 16 comprises a plurality of circular shaped sections 28 (of same or different size). FIG. 5 shows a number of circular shaped sections 28 that is smaller than the number of sections 27 of the fixed part 15; it is clear that the number of the sections 27 of the fixed part 15 and circular shaped sections 28 of the movable part 16 can be any according to the need.

The operation of the sealing system is apparent from that described and illustrated and is substantially the following.

When the turbine 1 is not in operation, the movable part (and in particular the circular shaped sections 28 thereof) are maintained associated to the fixed part 15 of the sealing system 10 by the retainer (e.g. magnets 17 and/or stops 25). The fixed part 15 and movable part 16 of the sealing system 10 are thus coupled together as one system, preventing them from separating.

During operation of the turbine 1, hot gas passes through the vanes 5 and blades 6 and causes the rotor 3 to rotate.

The hot gas pushes the movable part 16 towards the fixed part 15 and the first surface 18 of the movable part 16 is pushed and rests against the first surface 19 of the fixed part 15; this prevents hot gas leakage between the fixed part 15 and movable part 16. The secondary seals 20 improve this sealing effect.

In addition, the balance between the pressure of the hot gas leaking between the tip 8 of the blades 6 and the movable part 16 and the pressure between the movable part 16 and the fixed part 15 or stator 2 keeps the movable part at a close distance from the blade tips 8; this distance is adjusted by the pressure forces themselves when the size of the gap between the blade tips 8 and the stator 3 changes, e.g. because of thermal dilatation during a change in the load of the turbine or a transient operation or after start up.

Since during operation of the turbine the movable part 16 does not undergo mechanical forces (like elastic forces) the sealing effect is improved.

In addition, assembling stops or magnets is much easier and faster than assembling elastic elements.

The sealing system 10 can also be provided at the tip 30 of the vanes 5 or on the stator at a position thereof facing the rotor (i.e. not facing the blades but the rotor itself) or at compressor vanes.

Naturally the features described may be independently provided from one another. For example, the features of each of the attached claims can be applied independently of the features of the other claims.

In practice the materials used and the dimensions can be chosen at will according to requirements and to the state of the art.

### REFERENCE NUMBERS

1 rotating machine

2 stator

3 rotor

5 vane

6 blade

8 blade tip

10 sealing system

11 hot gas duct

15 fixed part

16 movable part

17 magnet

18 surface of 16

19 surface of 15

20 secondary seal

25 stop

26 recess

27 section of 15

28 circular shaped section of 16

30 vane tip

R radial direction

L longitudinal axis

1. A sealing system for a rotating machine, the sealing system comprising:
a fixed part;
a movable part, the fixed part being connectable to a stator of a rotating machine and the movable part being coupled to and movable to and fro the fixed part, wherein the movable part is mechanically disconnected from the fixed part; and
a retainer to prevent separation of the movable part from the fixed part.

2. The sealing system of claim 1, wherein the retainer comprises:
at least a magnet.

3. The sealing system of claim 1, wherein the retainer comprises:
at least two magnets cooperating with each other, at least one magnet being connected to the fixed part and at least another magnet being connected to the movable part.

4. The sealing system of claim 1, wherein the movable part is movable parallel to the fixed part, and the movable part has a surface arranged to rest against a corresponding surface of the fixed part following a movement of the movable part parallel to the fixed part.

5. The sealing system of claim 4, wherein the surface of the movable part extends towards the fixed part.

6. The sealing system of claim 5, wherein the surface of the fixed part is parallel to the surface of the movable part.

7. The sealing system of claim 1, comprising:
at least a secondary seal to prevent flow leakage between the fixed part and the movable part.

8. The sealing system of claim 4, wherein the at least a secondary seal is provided between the surface of the movable part and the surface of the fixed part.

9. The sealing system of claim 1, comprising:
a stop preventing separation of the fixed part from the movable part.

10. The sealing system of claim 1, wherein the fixed part has a circular shape and comprises:
at least two sections, and wherein the movable part comprises:
a plurality of circular shaped sections.

11. A rotating machine comprising:
a stator;
a rotor, the rotor having blades whose tips face the stator; and
connected to the stator and between the stator and the blade tip, a sealing system according to claim 1.

12. The rotating machine according to claim 11, configured as a turbine or a compressor or a turbogenerator or a hydrogenerator.

13. The rotating machine of claim 12, configured as part of a gas turbine engine.

14. A turbine or compressor vane, comprising:
a tip and a sealing system according to claim 1 at the tip.
